(19) United States
(12) Patent Application Publication
(10) Pub. No.: US 2020/0384295 A1
(43) Pub. Date: Dec. 10, 2020

(54) AUTOMATIC FIRE EXTINGUISHING DEVICE

(71) Applicant: Zhuhai RAVV Technology Co., Ltd., Zhuhai City (CN)

(72) Inventors: Maosong Zhou, Kunming City (CN); Shaolun Lin, Milpitas, CA (US)

(21) Appl. No.: 16/433,343

(22) Filed: Jun. 6, 2019

(51) Int. Cl. A62C 13/78; A47L 11/24; A47L 11/40; A62C 27/00; B25J 11/00

(52) U.S. Cl. CPC A62C 13/78; A47L 11/24; A47L 2201/02; A62C 27/00; B25J 11/0085; A47L 11/40

(57) ABSTRACT

The present invention relates generally to the technical field of smart home. More particularly, it relates to an automatic fire extinguishing device comprising a sweeping robot and a fire extinguishing mechanism, wherein said sweeping robot comprises a body, a processer, an abutting terminal and a camera. Said processor is disposed inside the body. Said abutting terminal is disposed on the side end surface of the body. Said camera is disposed on the upper end surface of the body. Said camera and the abutting terminal are both electrically connected to the processor; Said fire extinguishing mechanism comprises a supporting platform and a clamping mechanism, wherein said supporting platform is provided with a connecting terminal on the side and said supporting platform is connected to the sweeping robot via a limiting locking mechanism. Said supporting platform is provided with a swinging mechanism for placing a fire extinguisher. Said clamping mechanism is fixed at the control handle of the fire extinguisher. Said clamping mechanism is wirelessly connected to the processor; The invention realizes automatic fire extinguishing by integrating the sweeping robot and the fire extinguishing mechanism into a simple structure, which takes up less space and reduces the cost.

### TECHNICAL FIELD

The present invention relates generally to the technical field of smart home. More particularly, it relates to an automatic fire extinguishing device.

### STATE OF THE PRIOR ART

The automatic fire extinguishing devices currently used indoors are special equipment of relatively large size, which has only single functions and occupies much space.

### SUMMARY OF THE INVENTION

To solve the problems in the prior art, the present invention provides an automatic fire extinguishing device that is multi-functional and does not occupy much space.

The invention provides an automatic fire extinguishing device, comprising:

A sweeping robot, wherein said sweeping robot comprises a body, a processer, an abutting terminal and a camera. Said processer is disposed in said body. Said abutting terminal is disposed on the side end surface of the body. Said camera is disposed on the upper end surface of the body. Said camera and the abutting terminal are both electrically connected to the processor;

A fire extinguishing mechanism, wherein said fire extinguishing mechanism comprises a supporting platform and a clamping mechanism. Said supporting platform is provided with a swinging mechanism for adjusting the spraying angle of the fire extinguisher. Said fire extinguisher is disposed in the swinging mechanism. Said clamping mechanism is fixed on the control handle of said fire extinguisher. Said clamping mechanism is wirelessly connected with the processor;

Said supporting platform is provided with a connecting terminal on the side and said supporting platform is connected to said sweeping robot via a limiting locking mechanism.

As a further improvement of the present invention, said swinging mechanism comprises two supporting plates, a supporting base, two swinging arms, at least one swinging motor for driving the swinging arms to swing, and a retaining ring for fixing the fire extinguisher, wherein the two supporting plates are disposed symmetrically on two sides of the upper end of the supporting platform, and the upper ends of the two supporting plates are respectively provided with a horizontal supporting portion. Said swinging motor is disposed in said supporting portion. The upper ends of said two swinging arms are respectively hinged with said two supporting portions while the lower ends of said two swinging arms are respectively connected to the two ends of said supporting base. Said retaining ring is disposed between the upper ends of the two swinging arms.

As a further improvement of the present invention, said clamping mechanism comprises a linear motor, a driving power supply and a clamping circuit board, wherein said linear motor is fixed onto the lower holder of the control handle of said fire extinguisher. The outlet end of said linear motor is provided with a roller wheel. Said roller wheel is mounted on the upper holder of the control handle of said fire extinguisher. Said driving power supply and said linear motor are both electrically connected to said clamping circuit board while said clamping circuit board is wirelessly connected with said processor.

As a further improvement of the present invention, said supporting platform is further provided with a swinging circuit board, wherein said swinging motor and said connecting terminal are both electrically connected to the swinging circuit board.

As a further improvement of the present invention, said limiting locking mechanism comprises a limiting hole disposed on the side end surface of said body and an automatic lock catch disposed on the side end surface of said supporting platform, wherein said limiting hole is disposed on both sides of said abutting terminal while said automatic lock catch is disposed on both sides of said connecting terminal.

As a further improvement of the present invention, the lower end of said supporting platform is provided with a rolling mechanism.

As a further improvement of the present invention, said rolling mechanism is a universal wheel.

As a further improvement of the present invention, said sweeping robot further comprises a sweeping assembly and a driving wheel, wherein said sweeping assembly and driving wheel are both disposed at the lower end of said body.

As a further improvement of the present invention, said fire extinguisher is a portable fire extinguisher.

The present invention has the beneficial effects that the automatic fire extinguishing device of the invention comprises a sweeping robot and a fire extinguishing mechanism. Under normal circumstances, the sweeping robot is separated from the fire extinguishing mechanism and the sweeping robot realizes its functions of floor sweeping and surroundings monitoring. When fire danger occurs, it will quickly reach the position of the fire extinguishing mechanism and take the fire extinguishing mechanism to complete fire extinguishing. Simple in structure, and safe and reliable in operation, the invention is able to detect fire danger timely and make response promptly, thus effectively avoiding the spread of fire. In addition, the product of the invention has various functions, takes up less space and reduces the cost.

### BRIEF DESCRIPTION OF THE DRAWINGS

FIG. 1 is a schematic view illustrating the structure of the automatic fire extinguishing device of the present invention with the sweeping robot and fire extinguishing mechanism separated;

FIG. 2 is a schematic view illustrating the structure shown in FIG. 1 from another perspective.

Reference signs: 1—sweeping robot; 2—fire extinguishing mechanism; 11—camera; 12—abutting terminal; 21—supporting platform; 22—supporting base; 23—retaining ring; 24—supporting portion; 25—clamping mechanism; 26—connecting terminal; 3—fire extinguisher.

### DETAILED DESCRIPTION OF PREFERRED EMBODIMENTS

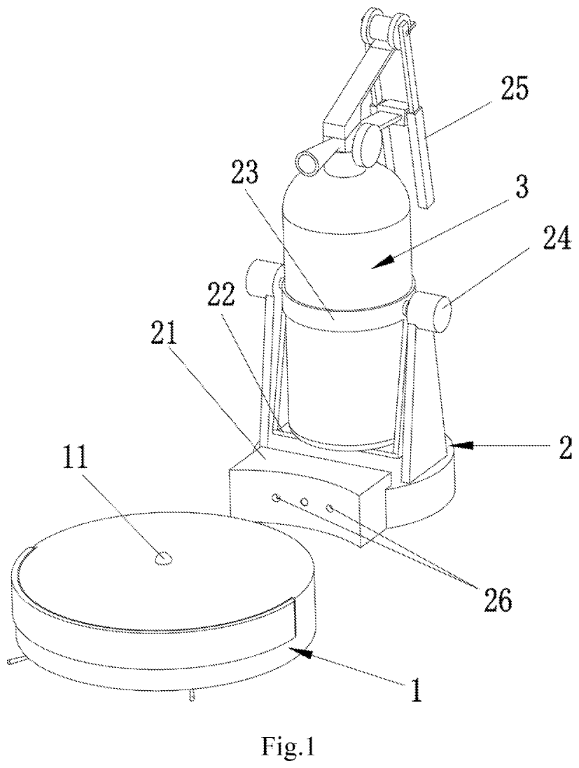

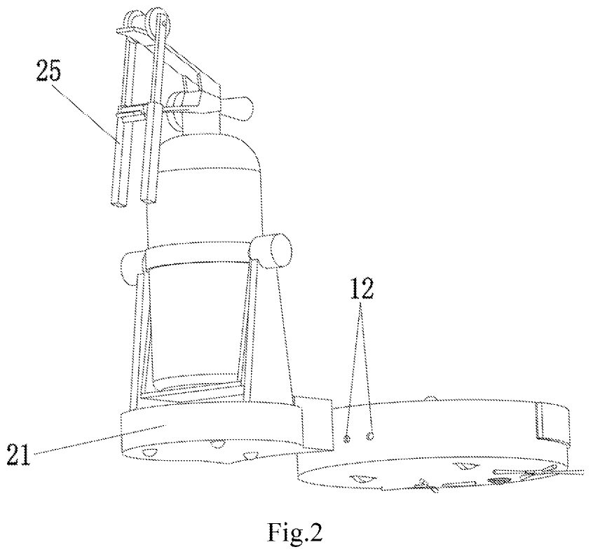

As shown in FIG. 1 and FIG. 2, the present invention discloses an automatic fire extinguishing device, comprising a sweeping robot 1 and a fire extinguishing mechanism 2. Said sweeping robot 1 comprises a body, a processor, an abutting terminal 12 and a camera 11. Said processor is disposed inside the body. Said abutting terminal 12 is disposed on the side end surface of the body. Said camera 11 is disposed on the upper end surface of the body. Said camera 11 is a 360° rotating camera which is able to monitor the surroundings better. Said camera 11 and the abutting terminal 12 are both electrically connected to the processor. Said fire extinguishing mechanism 2 comprises a supporting platform 21 and a clamping mechanism 25. Said supporting platform 21 is provided with a swinging mechanism for adjusting the spraying angle of a fire extinguisher 3. Said fire extinguisher 3 is operatively disposed in the swinging mechanism. The pitch angle of spraying of the fire extinguisher 3 can be adjusted by the swinging mechanism so as to spray effectively at fire points of different heights. Said clamping mechanism 25 is fixed on a control handle of said fire extinguisher 3. Said clamping mechanism 25 is wirelessly connected with the processor to facilitate the spraying control of the fire extinguisher 3; The side of said supporting platform 21 is provided with a connecting terminal 26 adapted to said abutting terminal 12 for electrically connecting the sweeping robot 1 and the fire extinguishing mechanism 2, thus enabling the sweeping robot 1 to control the fire extinguishing mechanism 2 to extinguish fire. Said supporting platform 21 is connected to said sweeping robot 1 via limiting locking mechanism, which can effectively fix the sweeping robot 1 and supporting platform 21.

The automatic fire extinguishing device of the present invention comprises a sweeping robot 1 and a fire extinguishing mechanism 2. Under normal circumstances, the sweeping robot 1 is separated from the fire extinguishing mechanism 2. The fire extinguishing mechanism 2 is placed at a fixed position while the sweeping robot 1 is able to clean the room by sweeping the floor. When the camera 11 of the sweeping robot 1 captures a fire point, the processor will analyze the image. Once the fire point is confirmed, the sweeping robot 1 will quickly move to the position of the fire extinguishing mechanism 2 to connect the supporting base 22 and takes the fire extinguishing mechanism 2 to the fire point for fire extinguishing. It can adjust the spraying angle of the fire extinguisher 3 via the swinging mechanism according to the different position of the fire point. Meanwhile, the clamping mechanism 25 controls the control handle on the fire extinguisher 3, thus realizing the automatic fire extinguishing function. Simple in structure, and safe and reliable in operation, the invention is able to detect fire danger timely and make response promptly, thus effectively avoiding the spread of fire. In addition, the product of the invention has various functions, takes up less space, reduces the cost and enjoys better versatility as the fire extinguisher 3 can be easily replaced.

In the technical embodiment of the present invention, said swinging mechanism comprises two supporting plates, a supporting base 22, two swinging arms, at least one swinging motor for driving the swinging arms to swing, and a retaining ring 23 for fixing the fire extinguisher, wherein said two supporting plates are disposed symmetrically on two sides of the upper end of the supporting platform 21, and the upper ends of said two supporting plates are respectively provided with a horizontal supporting portion 24. Said swinging motor is disposed in said supporting portion 24. The upper ends of said two swinging arms are respectively hinged with said two supporting portions 24 while the lower ends of said two swinging arms are respectively connected to the two ends of said supporting base 22. Said retaining ring 23 is disposed between the upper ends of the two swinging arms. The pitch angle of the two swinging arms can be adjusted via the swinging motor so as to adjust the spraying angle of the fire extinguisher 3, thus extinguishing fires of different heights effectively.

In the technical embodiment of the present invention, said clamping mechanism 25 comprises a linear motor, a driving power supply and a clamping circuit board, wherein said linear motor is fixed onto the lower holder of the control handle of said fire extinguisher 3. The outlet end of said linear motor is provided with a roller wheel. Said roller wheel is mounted on the upper holder of the control handle of said fire extinguisher 3. Said driving power supply and said linear motor are both electrically connected to said clamping, circuit board while said clamping circuit board is wirelessly connected with said processor. The processor can transmit signals to the clamping circuit board via Bluetooth, Wi-Fi or other wireless communication modules so as to control the linear motor, which drives the roller wheel to clamp the upper and lower holders of the fire extinguisher 3 to start the spraying of the fire extinguisher 3. It is easy to control and convenient to be fixed on holders of the portable fire extinguisher 3, which enjoys better versatility as the fire extinguisher 3 can be easily replaced.

In the technical embodiment of the present invention, said supporting platform 21 is further provided with a swinging circuit board, wherein said swinging motor and said connecting terminal 26 are both electrically connected to the swinging circuit board. The processor controls the swinging motor to rotate via the swinging circuit board.

In the technical embodiment of the present invention, said limiting locking mechanism comprises a limiting hole disposed on the side end surface of said body and an automatic lock catch disposed on the side end surface of said supporting platform 21, wherein said limiting hole is disposed on both sides of said abutting terminal 12 while said automatic lock catch is disposed on both sides of said connecting terminal 26. Therefore, when the sweeping robot 1 joins with the support platform 21, the limiting locking mechanism can be used to achieve the limit locking.

In the technical embodiment of the present invention, the lower end of said supporting platform 21 is provided with a rolling mechanism, which is convenient for the sweeping robot 1 to take the fire extinguishing mechanism 2 to the fire point. Said rolling mechanism is a universal wheel so that fire extinguishing mechanism 2 can move more easily with the sweeping robot 1.

In the technical embodiment of the present invention, said sweeping robot 1 further comprises a sweeping assembly and a driving wheel, wherein said sweeping assembly and driving wheel are both disposed at the lower end of said body.

In the technical embodiment of the present invention, said fire extinguisher is a portable fire extinguisher which is better in versatility, lower in cost, less in space occupation and easy to replace.

The present invention realizes automatic fire extinguishing by integrating the sweeping robot and the fire extinguishing mechanism into a simple structure, which has functions of floor sweeping and firefighting at the same time. Under normal circumstances, the sweeping robot is separated from the fire extinguishing mechanism. The fire extinguishing mechanism 2 is fixed in a position while the sweeping robot 1 realizes its functions of floor sweeping. It takes up less space and is lower in cost.

The above is a further detailed description of the present invention in connection with the specific preferred embodiments, which is not intended to limit the specific embodiments of the present invention to the description. It should be understood to those ordinary skilled in the art that extensions or substitutions of the present invention could be made hereto without departing from the spirit and scope of the invention, which shall fall within the scope of the present invention.

1. An automatic fire extinguishing device, comprising:
A sweeping robot, wherein said sweeping robot comprises a body, a processer, an abutting terminal and a camera. Said processer is disposed in said body. Said abutting terminal is disposed on the side end surface of the body. Said camera is disposed on the upper end surface of the body. Said camera and the abutting terminal are both electrically connected to the processor;
A fire extinguishing mechanism, wherein said fire extinguishing mechanism comprises a supporting platform and a clamping mechanism. Said supporting platform is provided with a swinging mechanism for adjusting the spraying angle of the fire extinguisher. Said fire extinguisher is disposed in the swinging mechanism. Said clamping mechanism is fixed on the control handle of said fire extinguisher. Said clamping mechanism is wirelessly connected with the processor;
Said supporting platform is provided with a connecting terminal on the side and said supporting platform is connected to said sweeping robot via a limiting locking mechanism.

2. The automatic fire extinguishing device according to claim 1, wherein said swinging mechanism comprises two supporting plates, a supporting base, two swinging arms, at least one swinging motor for driving the swinging arms to swing, and a retaining ring for fixing the fire extinguisher. Said two supporting plates are disposed symmetrically on two sides of the upper end of the supporting platform, and the upper ends of said two supporting plates are respectively provided with a horizontal supporting portion. Said swinging motor is disposed in said supporting portion. The upper ends of said two swinging arms are respectively hinged with said two supporting portions while the lower ends of said two swinging arms are respectively connected to the two ends of said supporting base. Said retaining ring is disposed between the upper ends of the two swinging arms.

3. The automatic fire extinguishing device according to claim 1, wherein said clamping mechanism comprises a linear motor, a driving power supply and a clamping circuit board. Said linear motor is fixed onto the lower holder of the control handle of said fire extinguisher. The outlet end of said linear motor is provided with a roller wheel. Said roller wheel is mounted on the upper holder of the control handle of said fire extinguisher. Said driving power supply and said linear motor are both electrically connected to said clamping circuit board while said clamping circuit board is wirelessly connected with said processor.

4. The automatic fire extinguishing device according to claim 2, wherein said supporting platform is further provided with a swinging circuit board. Said swinging motor and said connecting terminal are both electrically connected to the swinging circuit board.

5. The automatic fire extinguishing device according to claim 1, wherein said limiting locking mechanism comprises a limiting hole disposed on the side end surface of said body and an automatic lock catch disposed on the side end surface of said supporting platform. Said limiting hole is disposed on both sides of said abutting terminal while said automatic lock catch is disposed on both sides of said connecting terminal.

6. The automatic fire extinguishing device according to claim 1, wherein the lower end of said supporting platform is provided with a rolling mechanism.

7. The automatic fire extinguishing device according to claim 6, wherein said rolling mechanism is a universal wheel.

8. The automatic fire extinguishing device according to claim 1, wherein said sweeping robot further comprises a sweeping assembly and a driving wheel. Said sweeping assembly and driving wheel are both disposed at the lower end of said body.

9. The automatic fire extinguishing device according to claim 1, wherein said fire extinguisher is a portable fire extinguisher.
